(19) United States
(12) Patent Application Publication
(10) Pub. No.: US 2015/0176997 A1
(43) Pub. Date: Jun. 25, 2015

(54) ADAPTIVE TRANSPORTATION FRAMEWORK

(71) Applicants: Andreas Kurt PURSCHE, Singapore (SG); Abraham Sasmito ADIBOWO, Singapore (SG); Tow Yang CHIAM, Singapore (SG); Kar Leong TEW, Singapore (SG); Inez CAHYANI, Singapore (SG)

(72) Inventors: Andreas Kurt PURSCHE, Singapore (SG); Abraham Sasmito ADIBOWO, Singapore (SG); Tow Yang CHIAM, Singapore (SG); Kar Leong TEW, Singapore (SG); Inez CAHYANI, Singapore (SG)

(21) Appl. No.: 14/138,106

(22) Filed: Dec. 22, 2013

(51) Int. Cl. G01C 21/00; G08G 1/0967; G01C 21/26

(52) U.S. Cl. CPC G01C 21/00; G01C 21/26; G08G 1/0967

(57) ABSTRACT

Described herein is a framework to facilitate adaptive transportation. In accordance with one aspect of the framework, sensor data from a user device is monitored to detect movement of a user during a trip to a venue of an activity. In response to detecting movement of the user, trip information is acquired via the user device. Such trip information may be streamed to a populace load balancer, a forecasting system, a transport analytics system or a combination thereof.

### TECHNICAL FIELD

The present disclosure relates generally to computer systems, and more specifically, to a framework for adaptive transportation.

### BACKGROUND

Commuters routinely travel to and from regular destinations each day. Such regular destinations include, for example, work place, home, supermarkets, malls, recreation centers, etc. Although commuters typically know their daily route and traffic conditions very well, there may be occasions where there are unexpected deviations caused by unforeseen traffic incidents (e.g., congestion, accidents, construction work, etc.).

There is currently a lack of an effective means for communicating information of unexpected deviations in routine travel to commuters. Even though real-time traffic information is presently available, it is mostly consumed by navigation applications (e.g., Google Maps) that are rarely used by commuters since they know the directions to their regular destinations so well. The effectiveness of existing channels of notification for notifying commuters is limited. In many cases, they require users to actively look for information, or the information is distributed in a non-targeted manner.

Typically, when unexpected traffic incidents occur on a regular route, most commuters will independently move to the next best alternative route selected according to their individual best interests and prior knowledge. As a result, common alternative routes may be the next congestion points while further possible routes are under-utilized. In other words, route optimization is performed on the micro-level by individual commuters, and may therefore be sub-optimal at the macro level and result in inefficiencies for the entire population of commuters.

Another micro-level decision-making activity is associated with taxi drivers and other transport service providers. Many taxi drivers operate services that charge customers based on distance and/or time traveled. Hence, in order to maximize travel distance, frequency and customer service duration, many taxi drivers station their services in specific parts of a region, leaving other regions less serviced.

Further, public transport service operators may not be able to meet demand requirements for areas where demand for service is more concentrated during peak hours. Current public transportation capacity allocation or planning methodologies are rather inflexible and lack detailed knowledge of commuting patterns of individuals, their reasons for their choices for particular modes of transportation and behavioral changes over time.

### SUMMARY

A framework for facilitating adaptive transportation is described herein. In accordance with one aspect of the framework, sensor data from a user device is monitored to detect movement of a user during a trip to a venue of an activity. In response to detecting movement of the user, trip information may be acquired via the user device. Such trip information may then be streamed to a populace load balancer, a forecasting system, a transport analytics system or a combination thereof.

In accordance with another aspect of the framework, a user's regular activities are learned based at least in part on sensor data from a user device. Information of such regular activities may be stored and used to detect an upcoming regular activity. The user may be alerted, via the user device, of any potential deviation of a trip to a venue of the regular activity. Targeted messages that are relevant to the user may further be presented on the user device.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2a shows an exemplary method of providing assistance for transportation to venues of regular activities;

FIG. 2b shows an exemplary method of learning a user's regular activities;

FIG. 3a shows an exemplary regular activity dashboard;

FIG. 3b shows an exemplary schedule dashboard;

FIG. 4 shows an exemplary method of providing assistance for transportation to venues of irregular activities;

FIG. 5 shows an exemplary itinerary assistance method;

FIG. 6a shows an exemplary notification message;

FIG. 6b shows an exemplary method of detecting an abnormal event;

FIG. 7 shows an exemplary targeted advertisement; and

FIG. 8 shows an exemplary method of targeted advertising.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for facilitating adaptive transportation is described herein. In some implementations, the present framework effectively communicates relevant trip-related information (e.g., real-time traffic information) to users. The framework may employ a mobile application installed on user devices to collect and process user information so as to assist the users in making trips to their regular or non-regular activity venues. By considering, for example, each user's schedule, recent activities and profile, the present framework provides better foresight into the user's commuting plans and intended travel. Aggregating such user information advantageously allows the framework to determine past, current and future commuting behaviors of the user. The mobile application may dynamically remind the user to fulfill a scheduled appointment and provide traffic-aware suggestions on the transportation mode and/or driving route. Such features indirectly affect the future outcome and greatly improve predictions of commuting patterns.

The mobile application may also be leveraged upon to acquire previously unknown information, including, but not limited to, the expected mode of travel, time spent waiting for public transportation vehicle to arrive, crowd level at the user's current location, etc. Such information provides valuable insight for transport operators, regulators and commuters. A further advantage of the integrated solution is the end-to-end feedback mechanism that is bidirectional and interactive. Operators, system planners, advertisement sponsors and other stakeholders may view and push personalized messages to commuters, while commuters may consume and provide feedback regarding the information that they have received.

It should be appreciated that the framework described herein may be implemented as a method, a computer-controlled apparatus, a computer process, a computing system, or as an article of manufacture such as a computer-usable medium. These and various other features will be apparent from the following description.

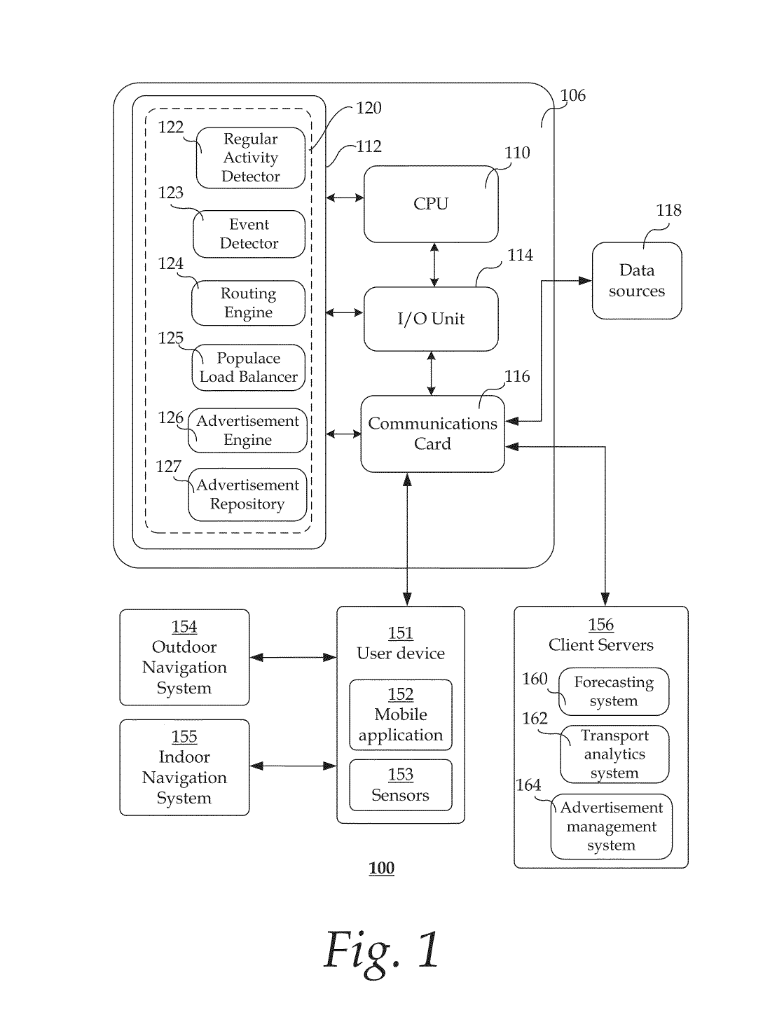

FIG. 1 is a block diagram illustrating an exemplary architecture 100 in accordance with one aspect of the present framework. Generally, exemplary architecture 100 may include a computer system 106, one or more data sources 118, one or more user devices 151 and one or more client servers 156.

Computer system 106 can be any type of computing device capable of responding to and executing instructions in a defined manner, such as a workstation, a server, a portable laptop computer, another portable device, a mini-computer, a mainframe computer, a storage system, a dedicated digital appliance, a device, a component, other equipments, or some combination of these. Computer system 106 may include a central processing unit (CPU) 110, an input/output (I/O) unit 114, a memory module 112 and a communications card or device 116 (e.g., modem and/or network adapter) for exchanging data with a network (e.g., local area network (LAN), wide area network (WAN), Internet, etc.). It should be appreciated that the different components and sub-components of the computer system 106 may be located or executed on different machines or systems. For example, a component may be executed on many computer systems connected via the network at the same time (i.e., cloud computing).

Computer system 106 may further be communicatively coupled to one or more data sources 118. A data source 118 may be, for example, any database (e.g., relational database, in-memory database, etc.), a repository, an entity (e.g., set of related records), or a data set included in a database, website or third-party system. In some implementations, data sources 118 include a traffic or pedestrian information system, a geocoding system, a points-of-interest database (e.g., restaurants, shopping centers, airports, etc.), environmental data provider (e.g., weather, pollution, etc.), events repository (e.g., trade shows, concerts, movies, etc.), transportation operator's system (e.g., taxi, limousine, bus, train, etc.), or a combination thereof.

Computer system 106 may act as a server and operate in a networked environment using logical connections to one or more user devices 151 and one or more client servers 156. Each user device 151 may be associated with one or more particular users (e.g., commuters), and serve as an interface to send and receive information from computer system 106. In some implementations, a user device 151 is a mobile device that includes, but is not limited to, a smart phone, a tablet computer, a handheld laptop, a cellular device, a mobile phone, a gaming device, a portable digital assistant (PDA), a portable media player, a wireless device, a data browsing device, and so forth. User device 151 may include components similar to a computer system, such as an input device for receiving and processing user input (e.g., touch screen, keypad, freeform text recognition module, speech recognition module, etc.), an output device for displaying a graphical user interface, a communications card, memory for storing a mobile software application (or mobile app) 152 and data (e.g., personal information manager or PIM data), a processor for executing the mobile app 152, sensors 153 (e.g., accelerator, magnetometer, gyroscope, barometer, thermometer, etc.), and so forth.

Mobile application 152 may present a user interface to access one or more trip-related services, including services provided by computer system 106. The user interface may, for example, be integrated with, a personal information manager (PIM) that allows the user to enter and view personal information (e.g., schedule, calendar, reminders, contacts, address, etc.). Further, the user interface may present trip-related information provided by the computer system 106 (e.g., suggested modes of transportation, routing, relevant deals from merchants, etc.). Mobile application 152 may also include an activity recorder and pre-processor to respectively collect and process user information, as will be described in more detail in the following description.

In some implementations, user device 151 is communicatively coupled to an outdoor navigation system 154 and an indoor navigation system 155. Outdoor navigation system 154 provides a geographical location of the user device 151 with global coverage (e.g., outside a building). Such outdoor navigation system 154 may include satellite-based systems such as, for instance, Global Positioning System (GPS) or Global Navigation Satellite System (GLONASS). Indoor navigation system 155 provides a location of the user device 151 when it is inside a building or to provide local coverage. Instead of using satellites, the indoor navigation system 155 may rely on nearby anchors (i.e. nodes with a known position), which either actively locate tags or provide environmental context for devices to sense in order to provide location information. Exemplary indoor navigation systems 155 include, but are not limited to, radio-frequency identification (RFID) systems, Wi-Fi positioning systems, etc.

Client servers 156 serve to process trip-related information provided by the computer system 106. For example, client servers 156 may include a forecasting system 160, a transport analytics system 162, and an advertisement management system 164. Other types of systems are also possible. Each client server 156 may be associated with an organization, such as an enterprise (e.g., transportation operator), a regulator (e.g., government authority, road regulator, etc.), a research company, etc.

Memory module 112 of the computer system 106 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by CPU 110. As such, the computer system 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 of the computer system 106 includes an adaptive transportation engine 120 for implementing the techniques described herein. The adaptive transportation engine 120 may include, but is not limited to, a regular activity detector 122, an event detector 123, a routing (or navigation) engine 124, a populace load balancer 125, an advertisement engine 126, an advertisement repository 127, and so forth. It should be appreciated that some or all of these exemplary components may also be implemented in another computer system (e.g., user device 151).

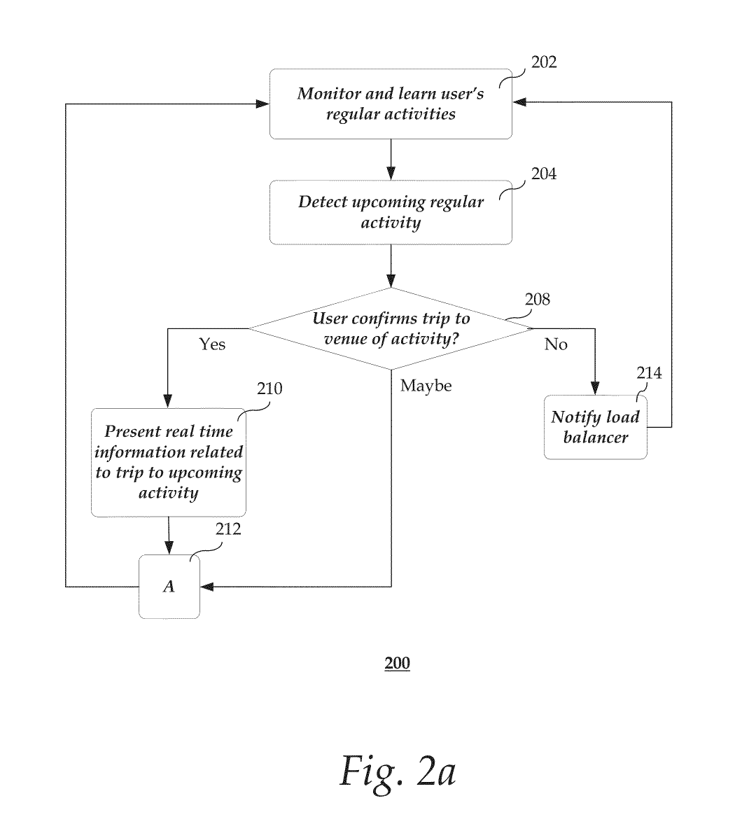

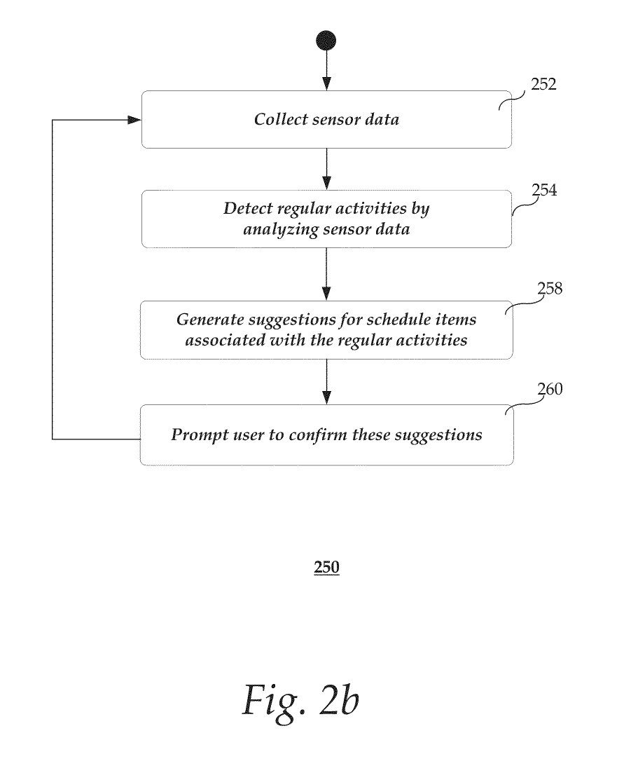

FIG. 2a shows an exemplary method 200 of providing assistance for transportation to venues of regular activities. The method 200 may be performed automatically or semi-automatically by the system 100, as previously described with reference to FIG. 1. It should be noted that in the following discussion, reference will be made, using like numerals, to the features described in FIG. 1.

At 202, the regular activity detector 122 monitors and learns the user's regular activities. A “regular activity” generally refers to an undertaking that occurs frequently enough over time to establish a pattern (though not necessarily a strict one). Examples of venues of such regular activities include, for example, work, home, place of worship, recreation center, etc.

FIG. 2b shows an exemplary method 250 of learning the user's regular activities. At 252, the regular activity detector 122 collects sensor data from the user device 151. Such sensor data may include, for example, data from the sensors 153 (e.g., accelerator, magnetometer, gyroscope, barometer, thermometer, etc.) of the user device 151, location data, and/or any other data that can be used to identify a particular user activity in a particular point in space and time. The location data may be provided by, for instance, the outdoor navigation system 154 and/or indoor navigation system 155. The location data may also be provided by identifying the base station location of the network cell currently serving the mobile application 152.

At 254, the regular activity detector 122 detects the user's regular activities by analyzing the sensor data. The regular activity detector 122 may detect a regular activity by analyzing the sensor data for regular patterns or similarities (e.g., user repeatedly or frequently visits the same location at particular times). The regular activity detector 122 may detect, for example, frequent locations (or venues), routes and/or mode of transportation (e.g., private car, taxi, bus, metro, train, airplane, ferry/ship, walking, biking, etc.) based on the sensor data. For modes of transportation that follow pre-defined routes and/or schedules, the regular activity detector 122 may identify, based on the speed, stops and/or route taken, particular public transportation services (e.g., bus number, train, etc.).

The regular activity detector 122 may store information associated with each detected regular activity in memory. Such regular activity information may include, but is not limited to, name of activity, time of the day, regular interval of repetition (e.g., day(s) of the week or month), location of user within venue of regular activity, location of regular activity venue, regular mode of transportation or route used by user to travel to the regular activity venue, and so forth. It should be appreciated that the location of the regular activity venue may be described by an address of the venue, geographical coordinates of a point representing the venue, name of area within which the venue is located (e.g., Clarke Quay area), and/or any other location identifying information.

At 258, the regular activity detector 122 may generate one or more suggestions for schedule items associated with the detected regular activities. The schedule items may be generated based on the current date and the regular interval of repetition associated with the regular activity. For example, if the current date is 31 May 2013 Wed, and the regular activity repeats every Thursday of the week, a suggestion for a schedule item may be generated for 1 Jun. 2013 Thursday.

At 260, the mobile application 152 may present the suggestion for a schedule item and prompt the user for confirmation. The user may confirm the schedule item or remove it from the list of suggestions. If the user confirms the schedule item, the mobile application 152 automatically adds it to the user's schedule data (or personal information data). The user may also manually add, via the mobile application 152, a schedule item for a regular activity. Further, the user may provide additional information, via the mobile application 152, of the regular activity (e.g., activity description, preferred mode of transportation, etc.).

The method 250 then repeats by returning to 252 to continue collecting and analyzing additional sensor data.

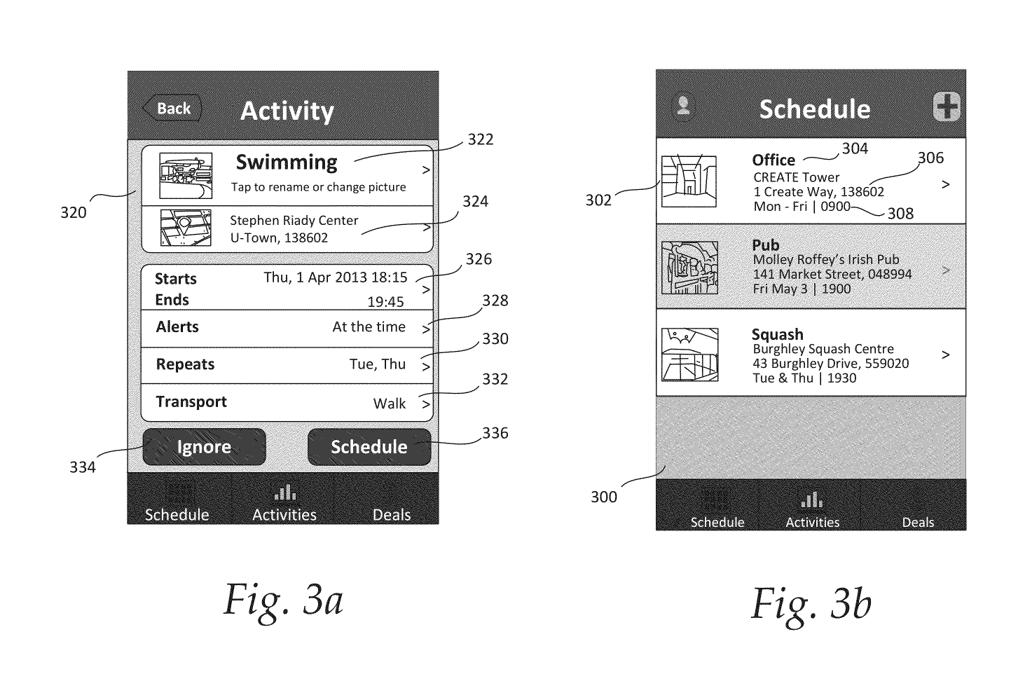

FIG. 3a shows an exemplary regular activity dashboard 320 presented by the mobile application 152. As shown, the regular activity dashboard 320 displays information associated with a suggestion of an upcoming regular activity schedule item. Information associated with the schedule item may include, for instance, a name 322, a location 324, start and end times 326, alerts activated by the user 328, regular intervals of repetition 330 and the mode of transportation 332 normally taken by the user. The dashboard 320 may also present user interface elements 334 and 336 for the user to select to ignore or schedule the activity respectively.

Returning to FIG. 2a, at 204, the mobile application 152 parses the schedule data and determines if there is any upcoming regular activity. The schedule data generally refers to information that indicates details (e.g., date, time, location, activity, attendees, etc.) of any appointment that has been set up for the user to fulfill. The schedule data may include information of irregular as well as regular activities detected by the regular activity detector 122, as previously described. The mobile application 152 may identify the upcoming regular activity based on the previously stored information of the user's regular activities. FIG. 3b shows an exemplary schedule dashboard 300 presented by mobile application 152. Each schedule item 302 identifies a particular appointment. The schedule data associated with each schedule item 302 may include a name 304, an address 306 of the venue and a date/time (or date/time range) 308.

If the mobile application 152 determines that a regular activity is scheduled within a predetermined time interval from the current time (e.g., within the next hour or day), the method proceeds to 208. Returning to FIG. 2a, at 208, the regular activity detector 122 may invoke the mobile application 152 to prompt the user to confirm if the user will be making the trip to the venue of the upcoming regular activity. The mobile application 152 may also prompt the user to indicate if any assistance is required to travel to such venue. The mobile application 152 may, for instance, present a confirmation message on user device 151 to prompt the user to indicate his or her selection. If the user confirms that the trip is going to be made, the method 200 proceeds to 210. Otherwise, if the user indicates that the trip to venue will not be made, the method 200 proceeds to 214. If the user does not affirmatively confirm or deny assistance (i.e. no selection is made), the method 200 continues at 212.

At 210, the mobile application 152 presents trip information related to the upcoming activity. The information may be provided substantially in real-time. Such information may include, but is not limited to, forecasts or updates regarding the user's preferred itinerary, such as particular modes of transportation (e.g., specific bus and train combination, driving route, etc.) that the user normally uses on the trip to the regular activity, alternative routes and corresponding modes of transportation, and so forth.

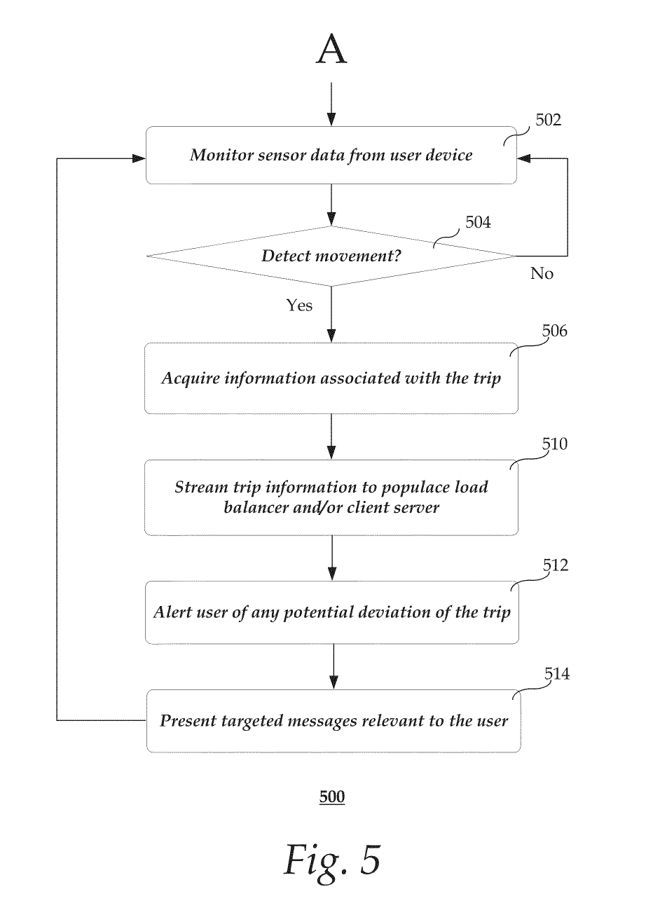

Returning back to FIG. 2a, at 212, the method 200 proceeds to initiate an itinerary assistance method 500, which will be described in more detail with reference to FIG. 5.

At 214, the mobile application 152 notifies the populace load balancer 125 that the user will not be making the trip to the venue of the upcoming activity. The populace load balancer 125 may serve to distribute the number of users or commuters across multiple transportation resources based on their individual capacities. Transportation resources may include, for example, modes of transportation (e.g., public transport, bus, taxi, train, etc.) or public roads (e.g., highway). Such load balancing aims to optimize the use of transportation resources and avoid overcrowding any one of these resources. By informing the populace load balancer 125 that the user will not be making the trip, the populace load balancer 125 notes that one less person will be using the relevant transportation resource and take action accordingly (i.e., feedback loop).

The method 200 then returns to step 202 to continue monitoring and learning the user's regular activities.

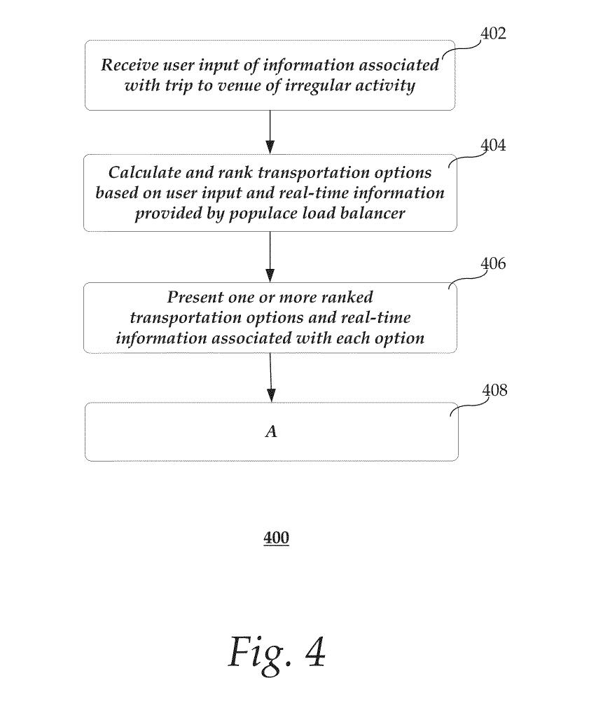

FIG. 4 shows an exemplary method 400 of providing assistance for transportation to venues of irregular activities. The method 400 may be performed automatically or semi-automatically by the system 100, as previously described with reference to FIG. 1. It should be noted that in the following discussion, reference will be made, using like numerals, to the features described in FIG. 1.

At 402, the mobile application 152 receives user input of information associated with a trip to a venue of an irregular activity. An “irregular activity” generally refers to an undertaking that occurs infrequently without establishing a pattern. Examples of such irregular activities include, for example, attending a concert, wedding or conference. The user may input information such as the destination venue, date, preferred transportation mode, desired time of arrival at venue, and so forth.

At 404, the populace load balancer 125 calculates and ranks one or more transportation options based on the user input provided by the mobile application 152 and real-time information. A transportation option may refer to a route that can be used by a car, taxi, any other vehicles or by walking to reach the venue. The populace load balancer 125 may invoke the routing engine 124 to determine one or more routes. The transportation option may also refer to one or more modes of public transportation, such as a particular bus, train service, etc., that the user may utilize to travel to the venue. The populace load balancer 125 may retrieve information of such modes of public transportation from the data source 118. It should be appreciated that each transportation option may include multiple modes of transportation (e.g., combination of bus and train).

In some implementations, the populace load balancer 125 ranks the transportation options based on the desired time of arrival at the venue and real-time information. The real-time information may include information of the current and/or forecasted (i.e. future) supply and demand for transportation resources (e.g., public roads, public transport). As discussed previously, the populace load balancer 125 may serve to distribute the number of commuters across multiple transportation resources based on their individual capacities. The highest ranked transportation option may indicate the most optimal option for the user as well as other users with intersecting itineraries (both in space and time dimensions). The populace load balancer 125 may also rank the transportation options differently for different users so as to influence the future demand for transportation resources. This is to avoid future congestion or overcrowding caused by many users choosing to utilize the same transportation resources.

At 406, the mobile application 152 presents one or more of the ranked transportation options from the populace load balancer 125. For example, the mobile application 152 may display, via the user device 151, the highest ranked transportation option as a suggestion to assist the user in reaching the venue before or by the desired time of arrival. In addition, the mobile application 152 may present the real-time information associated with each transportation option. For instance, the mobile application 152 may present information of the forecasted conditions (e.g., congestion or overcrowding) of each route or mode of transportation associated with the transportation option.

At 408, the method 400 proceeds to initiate an itinerary assistance method 500, which will be described in more detail with reference to FIG. 5.

FIG. 5 shows an exemplary itinerary assistance method 500. In some implementations, the method 500 is initiated to provide substantially real-time assistance to the user while the user is travelling to the venue of activity, and/or to provide feedback to the populace load balancer 125 and/or client servers 156. The method 500 may be performed automatically or semi-automatically by the system 100, as previously described with reference to FIG. 1. It should be noted that in the following discussion, reference will be made, using like numerals, to the features described in FIG. 1.

At 502, the mobile application 152 monitors sensor data from the user device 151. As discussed previously, the sensor data may include, for example, data from the sensors 153 (e.g., accelerator, magnetometer, gyroscope, barometer, thermometer, etc.) of the user device 151, location data, and/or any other data that can be used to detect movement of the user.

At 504, the mobile application 152 determines, based on the sensor data, if movement is detected. In other words, the mobile application 152 may determine if the user is traveling, or about to travel, from the current location to another location (or venue). If no movement is detected, the method 500 continues at 502 to continue monitoring the sensor data. If movement is detected, the method 500 continues at 506 while the user is traveling.

At 506, the mobile application 152 acquires information associated with the trip. In some implementations, such trip information includes information of one or more modes of transportation or driving routes that the user is currently using to travel to the venue of the activity. For example, the user may be using a combination of different modes of public transportation, such as a bus and a train. In another example, the user may be driving a personal vehicle on a public road. The trip information may include identification information of the particular instance of transportation vehicle (e.g., bus route number, bus “license plate”, etc.) currently used. Such information may be streamed as substantially real-time information to the populace load balancer 125 and/or the client servers 156.

The particular instance of transportation vehicle may be identified by, for instance, correlating the sensor data with substantially real-time information of public transport vehicles or public roads. For example, the current location of the user device 151 (based on the sensor data) may be matched with public transport vehicles at or within a predetermined distance from the same location. The matching process may result in a set of candidate vehicles. To identify the particular vehicle from the set of candidate vehicles, the “path” (i.e. recent historical locations) of each vehicle may be traced and matched with the path of the user device 151. By optionally matching the speeds of the vehicles with the speed of the user device 151 at a given point in time, the accuracy of the identification may be improved. In some implementations, a vehicle may directly or indirectly provide its identifier (ID) to the user device 151. For instance, a bus may provide a WIFI network or Bluetooth connection that can be used to determine the vehicle ID. The vehicle ID may also be provided when, for example, the user uses a Near field communication (NFC) enabled phone to pay the fare. Alternatively, if the user is traveling in a personal vehicle, the segment of public road that the user is currently driving on may be identified. The real-time information of public transport vehicles and public roads may be retrieved from, for example, an external data source 118.

In some implementations, the trip information is directly provided by the user. The mobile application 152 may interact with the user to confirm whether the user is taking the particular mode of transportation and instance of transportation vehicle as determined by the mobile application 152. In addition, the mobile application 152 may interact with the user to obtain feedback information of the situation of the transportation (e.g., level of overcrowding, traffic flow, events causing slow traffic, etc.) and the user's satisfaction with, or reaction to, the current transportation (e.g., bus captain's driving style, etc.).

Especially in areas where real-time traffic information is not available from other data sources, the mobile application 152 can advantageously be used to collect substantially real-time data of the current flow of traffic, and such information can advantageously be shared with other users of the mobile application 152 and other relevant stakeholders (e.g., road regulator). In addition to the traffic information, other types of information may also be acquired from the user. For example, the mobile application 152 may obtain user feedback on the level of overcrowding in buses and trains, the waiting time or the reasons for slow traffic situation (e.g., accident), and so forth.

At 510, the mobile application 152 may stream the trip information to the populace load balancer 125 and/or the client servers 156. In some implementations, the mobile application 152 notifies the populace load balancer 125 that the user is making the trip, and provides any additional acquired trip information (e.g., user feedback on transportation situation). The populace load balancer 125 may optimally distribute commuters across multiple transportation resources based on such information. For example, after a metro train breaks down, commuters may seek alternative modes of transportation (e.g., taxi, bus, etc.) to reach their desired destinations. Naturally, the decision of each commuter is the next best alternative. However, it is likely that fellow commuters will make the same decision. The trip information may provide the populace load balancer 125 with knowledge of the current available capacity for multiple modes of transportation, and enable it to determine the optimal distribution of commuters and recommend slightly different routes or modes of transportation for each user so as to achieve balancing of load.

In some implementations, the mobile application 152 streams such information to one or more client servers 156 where further action may be initiated. The client servers 156 may be used by a transportation operator, a road regulator or other stakeholders to influence future demand and supply for transportation resources based on transportation forecasts or analytics results. For example, a forecasting system 160 may use the trip information to improve the accuracy of forecasts of future supply (e.g., vehicle capacity shortfall prediction) and demand (e.g., overcrowding by commuters) for transportation resources. A transport analytics system 162 may also record such trip information to perform what-if analyses that simulate changes (e.g., add additional bus for certain bus route) and predict their impact. Simulations may be employed to support decision making for ad-hoc changes as well as changes impacting the transportation system in the longer term (e.g., bus route optimization, infrastructure planning, etc.).

At 512, the mobile application 152 alerts the user of any potential deviation that may be encountered during the course of the user's trip. Such deviation may be caused by an abnormal event that adversely affects traffic along the user's route. Such abnormal events may include, for example, traffic congestion, vehicle breakdown, interruption of public transportation system, transportation workers' strikes, accidents, road closures due to events, road blocks, and so forth.

The alert may be provided before or during the trip in response to a notification from the event detector 123. In addition, the alert may be provided in various different forms on the user device 151. In accordance with some implementations, the mobile application 152 presents a traffic-aware alarm clock that is designed to wake the user up at a specific time pre-set by the user. If a potential deviation is detected, the wake-up time may be automatically re-adjusted to an earlier time to accommodate additional time that may be required to travel to the venue on time.

In some implementations, the mobile application 152 serves as a smart assistant. The mobile application 152 may monitor schedule items retrieved from, for example, the user device's personal information manager or calendar. The mobile application 152 then generates a pop-up notification message to alert the user of any potential deviation associated with the schedule item. The notification message may inform the user that the route or mode of transportation taken or to be taken is not optimal (e.g., due to overcrowded buses, traffic congestion, etc.), and may present a solution for more optimal transportation.

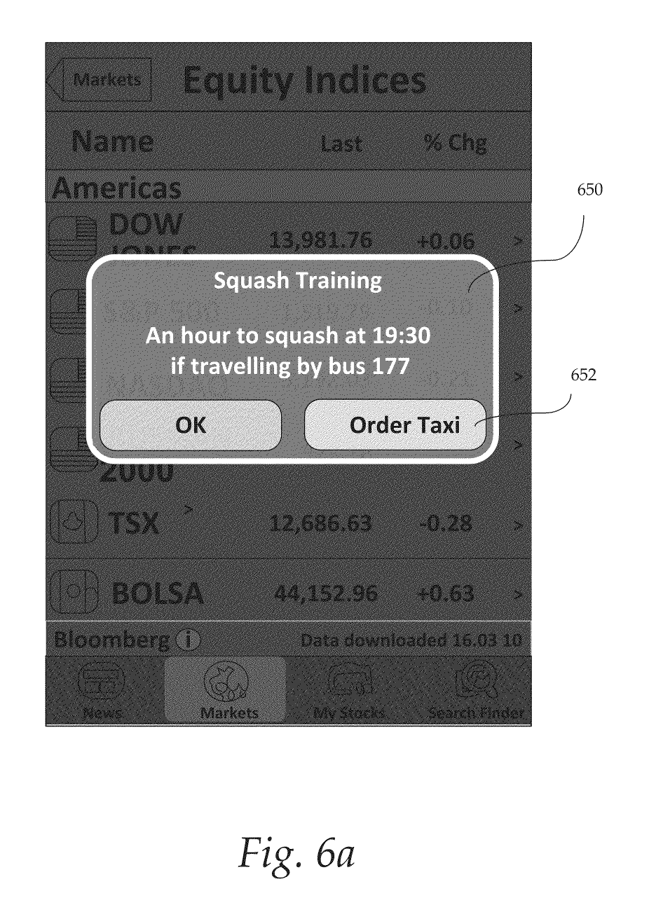

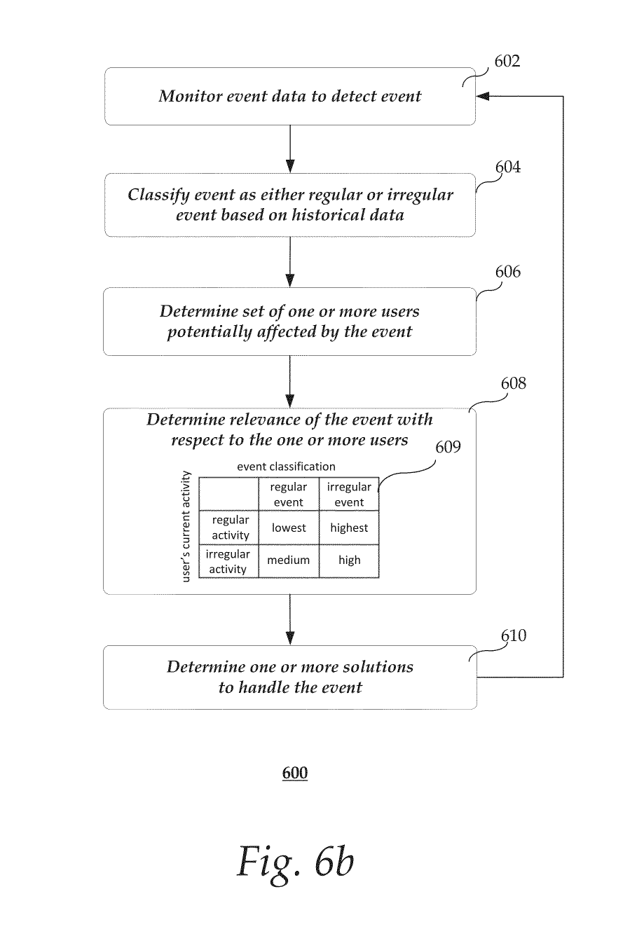

FIG. 6a shows an exemplary notification message 650. The notification message 650 may be generated as a traffic-aware pop-up reminder of a scheduled activity if a potential deviation is detected. As shown, the notification 650 includes the description of the schedule item (e.g. squash training) and the time to the venue of the activity (e.g., 1 hour) based on the expected travel time using the regular mode of transportation (e.g., bus 177). The expected travel time may be forecasted based at least in part on real-time traffic information (e.g., traffic congestion at certain routes). The notification message 650 also provides a user interface element 652 that offers a solution in response to the deviation. As shown, the solution includes selecting an alternate mode of transportation (e.g., taxi) so as to enable the user to arrive at the desired venue on time. In some implementations, the notification message 650 may be generated only in cases when the user has defined a reminder for the schedule item or if the deviation causes a delay beyond a predetermined threshold. Accordingly, the notification message 650 may not be generated in situations that the user may consider normal, such as when a vehicle or street is normally crowded.

FIG. 6b shows an exemplary method 600 of detecting an abnormal event. The method 600 may be performed automatically or semi-automatically by the system 100, as previously described with reference to FIG. 1. It should be noted that in the following discussion, reference will be made, using like numerals, to the features described in FIG. 1.

At 602, the event detector 123 monitors event data to detect one or more events. Such event data may be retrieved from, for example, data source 118. Event data generally refers to any information from which the detector 123 may discover abnormal occurrences that may cause a deviation in the user's trip. Event data may include, but is not limited to, real-time environment information (e.g., weather conditions, transportation conditions, traffic, etc.), sensor data indicative of user movement, information of upcoming activities (e.g., work, conferences, concerts, celebrations, trade shows, games, etc.), information of user interactions with mobile application 152, and so forth.

At 604, the event detector 123 classifies the event as either a regular or irregular event based on historical data. A “regular event” generally refers to a frequent occurrence that follows a pattern (though not necessarily a strict one), while an “irregular event” generally refers to an infrequent occurrence that does not follow any pattern. Machine learning may be employed to train a model based on historical data. The model may describe a “normal” situation, and can be used to classify a current event as regular or irregular.

At 606, the event detector 123 determines a set of one or more users who are potentially affected by the event. Such determination may be made by matching, for instance, each user's current activity information (e.g., location, time, mode of transportation, routes, etc.) with the event information (e.g., location, time, affected modes of transportation, affected roads, etc.). The affected users may be those who are traveling on substantially the same route that is affected by the event. Based on the detected event and the affected transportation mode, the load balancer 125 may determine the state of the transportation system.

At 608, the event detector 123 determines the relevance of the event with respect to each user in the set. In some implementations, the relevance is associated with 4 levels: lowest, medium, high and highest. Table 609 may be used to determine the relevance level based on the event classification and the user's current activity classification. As shown, a regular event that affects a regular user's activity may be assigned the lowest relevance level, while an irregular event that affects a regular user's activity may be assigned the highest relevance level. A regular event that affects an irregular user's activity may be assigned a medium relevance level, while an irregular event that affects an irregular user's activity may be assigned a high relevance level.

At 610, the event detector 123 determines one or more applicable solutions to handle the event. In some implementations, the event detector 123 initiates appropriate action to facilitate the solution. For example, the event detector 123 may invoke the mobile application 152 to advise the user to use an alternative mode of transportation or route. The mobile application 152 may provide a user interface element to enable the user to reserve the alternative mode of transportation (e.g., taxi), such as previously described with reference to FIG. 6a. The mobile application 152 may also provide targeted advertisements that delays demand for transportation resources or influence the user's driving routes. The user's eventual actions may be detected by an activity recorder in the user device 151, and fed back to the populace load balancer 125.

In some implementations, the event detector 123 may notify relevant stakeholders (e.g., transport operators, authorities, etc.) to take action for handling the event. Examples of such actions may include, but are not limited to, adding or reducing transport capacity (e.g., speed up or slow down buses, activate or deactivate “spare” buses from/to the pool, etc.), re-routing vehicles (e.g., dynamically changing bus numbers, etc.), and so forth.

After determining the one or more solutions to handle the detected event, the method 600 may return to step 602 to continue monitoring event data to further detect events.

An exemplary irregular activity scenario that involves the method 600 is as follows: the user is planning to attend a concert and has indicated the intention to do so via the mobile application 152. The event detector 123 detects the concert event from event data. The event data includes information of the time, location and estimated number of people attending the concert. Based on historical data, the event detector 123 may forecast a potential contention for public transportation at the end of the concert event. For example, the concert may end at a late night hour when there are typically fewer buses in operation, and many people may be leaving the concert venue at the same time. Accordingly, the event detector 123 may recommend a solution that involves pre-reservation of a taxi so that the user can be picked up by a taxi just after the concert.

An exemplary regular activity scenario that involves the method 600 is as follows: the user is planning to go to work (i.e. regular activity) and his preferred bus number 174 is as crowded as usual (i.e. regular event). The event detector 123 may invoke the mobile application 152 to unobtrusively display a high priority warning message at the user device 151 to notify the user. The message may notify the user, for example, that the bus is late because the street is closed due to an accident.

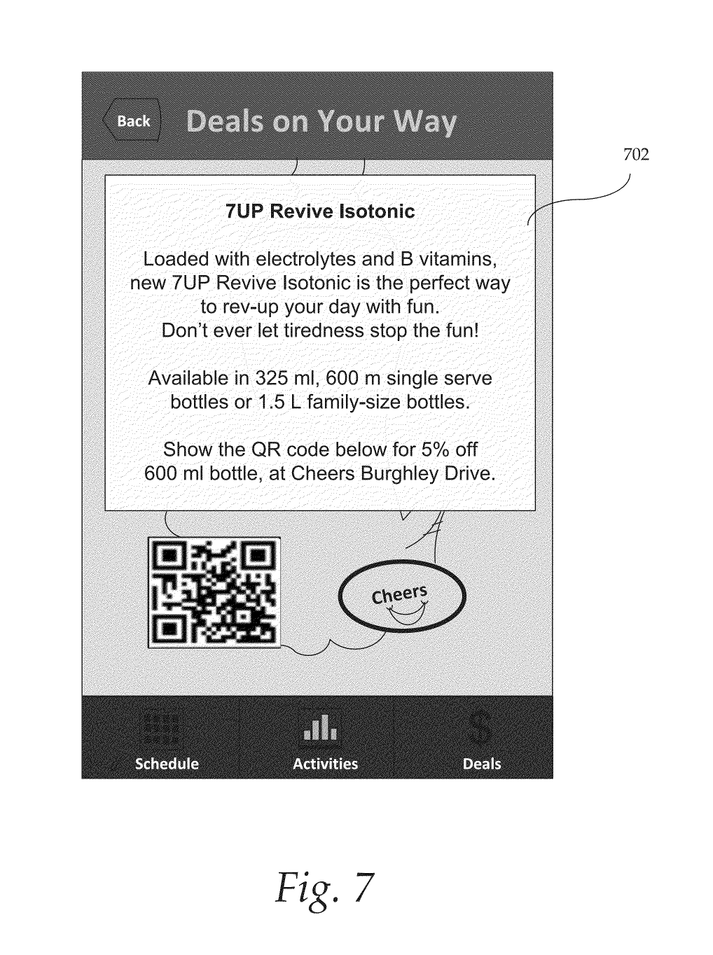

Returning to FIG. 5, at 514, the mobile application 152 may present one or more targeted messages that are relevant to the user. The targeted messages may include, for example, traffic information, deals and/or advertisements that are selected based on locations frequently visited by the user and anticipated destination of the current trip. For example, retailers may send offers or deals to commuters who regularly stay in a certain area. The advertisement may also be customized on the schedule data and/or trip profile. FIG. 7 shows an exemplary targeted advertisement 702 that may be displayed by the mobile application 152. The targeted advertisement 702 is customized based on the user's ongoing activity (e.g., sports).

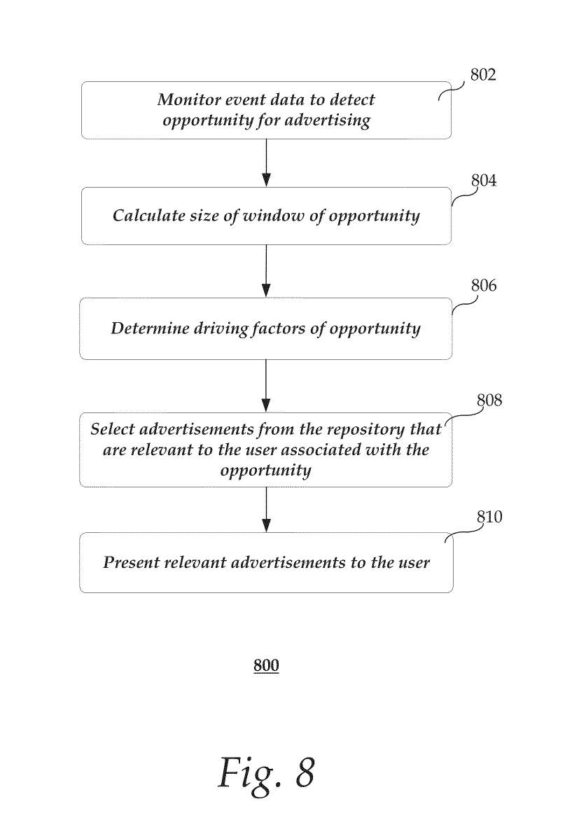

FIG. 8 shows an exemplary method of targeted advertising. The advertisement engine 126 monitors event data to detect at least one opportunity for advertising. Such event data generally refers to any information from which the advertisement engine 126 may discover opportunities (or favorable conditions) for advertising. An opportunity may be discovered when, for example, the user is encountering a deviation in the trip, traveling on the trip, interacting with the mobile application 152, and so forth. Event data may include, but is not limited to, real-time environment information (e.g., weather conditions, transportation conditions, traffic, etc.), sensor data indicative of user movement, information of upcoming activities (e.g., work, conferences, concerts, celebrations, trade shows, games, etc.), information of user interactions with mobile application 152, and so forth.

At 804, the advertisement engine 126 calculates the size of the window of opportunity. The window of opportunity is the time period during which it is particularly advantageous to present targeted advertisement. The size of the window of opportunity may be calculated based at least in part on the event information. In the case where the event is a user activity, the average duration of the activity may be used to calculate the size of the window of opportunity.

At 806, the advertisement engine 126 determines one or more driving factors of the opportunity. One or more parameters of advertisement presentation corresponding to the driving factors may further be determined. One exemplary driving factor includes load-balancing by the populace load balancer 125. The populace load balancer 125 may use targeted advertising to influence the real-time demand for transportation (e.g., public transportation, public roads used by personal vehicles). For instance, the populace load balancer 125 may delay the demand for transportation by sending targeted advertisements (e.g., deals) to one or more users so as to divert them to nearby shops and make room in the bus for other commuters to board. Other exemplary driving factors include, but are not limited to, the amount of disposable time the user has (e.g., while waiting for transportation vehicle to arrive), the financial incentives provided by the advertisement sponsor, and so forth.

Depending on the driving factor, one or more parameters of the advertisement presentation may be determined. Such parameters include, for example, the time of day at which to present the advertisement, content of the advertisement, period of time during which presenting the advertisement is appropriate, and so forth. In some implementations, the content of the advertisement is selected based on the type of activity the user is currently or commonly engages in. For example, while the user is traveling to work or school in the morning, it may be particularly advantageous to present an advertisement for a breakfast deal since it will likely be acceptable for the user to deviate slightly from the usual route to have a cup of coffee or breakfast. It may not be advantageous, however, to present advertisements related to movies or grocery shopping. The content of the advertisement may also be restricted based on the characteristics or customs of the user or the region in which the user is located. For example, advertisements of alcohol may not be acceptable in certain regions or for certain age groups.

At 808, the advertisement engine 126 selects relevant advertisements from the advertisement repository 127. The advertisement repository 127 stores a set of advertisements provided by, for instance, an advertisement management system 164 implemented at a client server 156 that is associated with an advertisement sponsor. Each advertisement includes text and/or graphics designed to attract public attention or patronage (e.g., description of goods for sale, announcements, deals, services, etc.).

The advertisement engine 126 may calculate a relevance score for each advertisement based on one or more scoring factors to determine the advertisements most relevant to the user associated with the opportunity. Scoring factors may be determined based on type of activities the user frequently engages in (e.g. sports, leisure, etc.), locations that the user frequently visits or bypasses (i.e. to select advertisements of goods or services that may be consumed in close proximity to the user), personal preferences indicated by the user (e.g., no deals related to alcohol), historical data (e.g., previous successful advertisements that were pushed to the user), and so forth.

At 810, the advertisement engine 126 presents the relevant advertisements to the user. The advertisements may be presented in the form of, for example, push notifications on the user device 151 or displayed while the user is interacting with the mobile application 152. Other methods of presenting the advertisements are also useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method of facilitating adaptive transportation, comprising:
learning a user's regular activities based at least in part on sensor data from a user device and storing information of the regular activities;
detecting an upcoming regular activity based on the stored information;
alerting, via the user device, the user of any potential deviation of a trip to a venue of the regular activity; and
presenting, via the user device, targeted messages that are relevant to the user.

2. A method of facilitating adaptive transportation, comprising:
monitoring sensor data from a user device to detect movement of a user during a trip to a venue of an activity;
in response to detecting movement of the user, acquiring trip information via the user device; and
streaming the trip information to a populace load balancer, a forecasting system, a transport analytics system or a combination thereof.

3. The method of claim 2 wherein acquiring the trip information comprises acquiring information of one or more modes of transportation, a particular instance of transportation vehicle or driving route that the user is using during the trip.

4. The method of claim 3 wherein acquiring the information of the particular instance of transportation vehicle comprises correlating the sensor data with substantially real-time information of public transport vehicles or public roads.

5. The method of claim 2 wherein acquiring the trip information comprises acquiring feedback information from the user of a current transportation situation, the user's satisfaction with or reaction to the current transportation.

6. The method of claim 5 wherein acquiring feedback information from the user of the current transportation situation comprises acquiring substantially real-time traffic information.

7. The method of claim 2 wherein streaming the trip information to the populace load balancer, the forecasting system, the transport analytics system or the combination thereof comprises:
providing the trip information to the populace load balancer and notifying the populace load balancer that the user is making the trip; and
optimally distributing, by the populace load balancer, demand or supply of transportation resources based on the trip information and the notification.

8. The method of claim 2 wherein streaming the trip information to the populace load balancer, the forecasting system, the transport analytics system or the combination thereof comprises:
providing the trip information to the forecasting system or the transport analytics system;
generating transportation forecasts or analytics results based on the trip information; and
influencing future demand or supply of transportation resources based on the transportation forecasts or analytics results.

9. The method of claim 2 further comprising alerting the user of any potential deviation of the trip.

10. The method of claim 9 wherein alerting the user of any potential deviation of the trip comprises:
providing, via a mobile application implemented on the user device, an alarm clock with a pre-set wake-up time; and
in response to detecting a potential deviation of the trip, automatically re-adjusting the wake-up time of the alarm clock to an earlier time.

11. The method of claim 9 wherein alerting the user of any potential deviation of the trip comprises:
monitoring schedule items retrieved from the user device; and
in response to detecting the potential deviation of the trip associated with at least one of the schedule items, presenting a pop-up notification message on the user device.

12. The method of claim 11 further comprising detecting the potential deviation of the trip by monitoring event data to detect an abnormal event.

13. The method of claim 12 further comprising determining one or more solutions to handle the abnormal event.

14. The method of claim 13 wherein the one or more solutions comprises presenting, on the user device, a user interface element to enable the user to reserve an alternative mode of transportation.

15. The method of claim 13 wherein the one or more solutions comprises presenting, on the user device, one or more targeted advertisements to delay demand for transportation resources.

16. The method of claim 13 wherein the one or more solutions comprises notifying one or more relevant stakeholders to take action for handling the event.

17. The method of claim 2 further comprising presenting, on the user device, one or more targeted advertisements.

18. The method of claim 2 wherein the activity is an irregular activity, and further comprising:
receiving user input of information associated with the trip to the venue of the irregular activity;
calculating and ranking transportation options based at least in part on the user input; and
presenting, via the user device, one or more of the ranked transportation options.

19. A non-transitory computer-readable medium having stored thereon program code, the program code executable by a computer to:
monitor sensor data from a user device to detect movement of a user during a trip to a venue of an activity;
in response to detecting movement of the user, acquire trip information via the user device; and
stream the trip information to a populace load balancer or a client server.

20. A system comprising:
a non-transitory memory device for storing computer-readable program code; and
a processor in communication with the memory device, the processor being operative with the computer-readable program code to
monitor sensor data from a user device to detect movement of a user during a trip to a venue of an activity,
in response to detecting movement of the user, acquire trip information via the user device, and
stream the trip information to a populace load balancer or a client server.
